(19) United States
(12) Patent Application Publication
(10) Pub. No.: US 2022/0405618 A1
(43) Pub. Date: Dec. 22, 2022

(54) GENERATING ROADWAY CROSSING INTENT LABEL

(71) Applicant: Waymo LLC, Mountain View, CA (US)

(72) Inventors: Khaled Refaat, Mountain View, CA (US); Yun Jia Guan, Sunnyvale, CA (US); Jeonhyung Kang, San Jose, CA (US)

(21) Appl. No.: 17/354,232

(22) Filed: Jun. 22, 2021

(51) Int. Cl. G06N 5/04; G06N 20/00

(52) U.S. Cl. CPC G06N 5/04; G06N 20/00

(57) ABSTRACT

Methods, systems, and apparatus, including computer programs encoded on computer storage media, for generating roadway crossing intent labels for training a machine learning model to perform roadway crossing intent predictions. One of the methods includes obtaining data identifying a training input, the training input including data characterizing an agent in an environment as of a given time, wherein the agent is located in a vicinity of a roadway in the environment at the given time. Future data characterizing (i) the agent, (ii) the environment or (iii) both over a future time period that is after the given time is obtained. From the future data, an intent label that indicates a likelihood that the agent intended to cross the roadway at the given time is determined. The training input is associated with the intent label in training data for training the machine learning model.

### BACKGROUND

This specification relates to autonomous vehicles.

Autonomous vehicles include self-driving cars, boats, and aircrafts. Autonomous vehicles use behavior prediction models to generate behavior predictions, e.g., pedestrian behavior prediction, or vehicle trajectory prediction, and use such behavior predictions to make control and navigation decisions. The behavior prediction models can include one or more trained machine learning models that select which trajectory is predicted to occur in the future, e.g., whether a pedestrian is going to cross the roadway, or whether a vehicle is going to make a left turn, right turn, or driving straight, and so on. These machine learning models are trained using labeled training data, and the label indicates what behavior actually happened in the future.

Some autonomous vehicles have computer systems that implement neural networks for vehicle trajectory prediction from sensor data, e.g., radar data, lidar data, camera data and so on. For example, a neural network can be used to determine whether a vehicle in an image captured by an on-board camera is likely to make a left turn in a future period of time.

Autonomous and semi-autonomous vehicle systems can use full-vehicle predictions for making driving decisions. A full-vehicle prediction is a prediction about a region of space that is occupied by a vehicle. The predicted region of space can include space that is unobservable to a set of on-board sensors used to make the prediction.

Autonomous vehicle systems can make full-vehicle predictions using human-programmed logic. The human-programmed logic specifies precisely how the outputs of on-board sensors should be combined, transformed, and weighted, in order to compute a full-vehicle prediction.

### SUMMARY

This specification describes how a computer system can generate training data for training a machine learning model to generate roadway crossing intent predictions for agents in an environment.

Autonomous vehicles use behavior prediction models to generate behavior predictions, and use such behavior predictions to make control and navigation decisions. However, the behavior predictions may not be sufficient in some situations, and autonomous vehicles may need to predict the intents of the agents in the environment, such as a roadway crossing intent of a pedestrian. Intent predictions estimate the latent desire by agents to execute an action. That is, intent predictions predict the intended action of an agent, even if that action may not necessarily be executed. In some implementations, although the agent executed the intended action after a period of time, data that captures the execution of the intended action is not available. For example, the autonomous vehicle has left the scene before the agent executed the intended action, or the agent is not within the field of view of the autonomous vehicle when the agent executes the intended action.

For example, a pedestrian may want to cross the road, but may not cross in the near future because the pedestrian crossing light is red, or because passing vehicles are not giving the pedestrian the chance to cross. As another example, the autonomous vehicle did not capture the execution of the roadway crossing because the autonomous vehicle had already left the scene when the pedestrian crossed the roadway at a later time after the given time, and the pedestrian was not within the field of view of the autonomous vehicle's sensors when the pedestrian crossed the roadway. In these examples, the behavior prediction model can predict that the pedestrian is not going to cross within a period of time. However, it is important that the system can determine that the pedestrian is intending to cross, such that the autonomous vehicle can make control and navigation decisions based on both the behavior predictions and the intent predictions, e.g., by stopping to give the pedestrian the chance to cross the roadway because the pedestrian has the right of way.

Autonomous vehicles can use intent prediction models to generate intent predictions. The intent prediction models can include one or more machine learning models that generate intent predictions for agents in an environment. These machine learning models are trained using labeled training data. Training a machine learning model, especially a neural network, requires a large amount of labeled training data, e.g., hundreds of or millions of labeled training examples, such that the trained machine learning model can generate accurate predictions.

However, generating a large amount of ground truth labels for the training data can be challenging. Conventionally, behavior prediction labels for training examples are generated based on what actually happened in a future time period. For example, an auto-labeling approach can be used to label training examples automatically by searching for what happened in the logs that record the history of what the agent ended up doing in the future time period. However, this conventional approach labels the training data based on what happened in a future time period rather than what the agent intended to do at the time of prediction. Therefore, it is difficult to train or evaluate intent prediction machine learning models using the labeled training data generated for behavior predictions.

Alternatively, a human labeling process requires human labelers to view a video and estimate the intent of an agent. The human labeling process can be expensive and time consuming, and can often involve the training and validation of the human labelers. Therefore, it is not practical to generate a large amount of labeled training data using human labelers. Furthermore, the intent labels generated by multiple human labelers can be inconsistent because the intent labels are subject to the different subjective decisions of the multiple human labelers.

In general, one innovative aspect of the subject matter described in this specification can be embodied in methods that include the actions of obtaining data identifying a training input, the training input including data characterizing an agent in an environment as of a given time, wherein the agent is located in a vicinity of a roadway in the environment at the given time; obtaining future data characterizing (i) the agent, (ii) the environment or (iii) both over a future time period that is after the given time; determining, from the future data, an intent label that indicates a likelihood that the agent intended to cross the roadway at the given time; and associating the training input with the intent label in training data for training a machine learning model. Other embodiments of this aspect include corresponding computer systems, apparatus, and computer programs recorded on one or more computer storage devices, each configured to perform the actions of the methods. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The foregoing and other embodiments can each optionally include one or more of the following features, alone or in combination. In particular, one embodiment includes all the following features in combination. The actions further include training the machine learning model on the training data. The intent label includes a probability that the agent intended to cross the roadway at the given time. The intent label is a binary label. The future data indicates whether the agent crossed or entered the roadway within a first threshold amount of time after the given time, and determining the intent label includes determining that the agent intended to cross the roadway at the given time when the future data indicates that the agent crossed or entered the roadway within the first threshold amount of time. The future data indicates whether the agent crossed or entered the roadway within a first threshold amount of time after the given time, and determining the intent label includes when the future data indicates that the agent did not cross or enter the roadway within the first threshold amount of time: determining, from the future data, whether each of one or more additional criteria are satisfied; and determining that the agent did not intend to cross the roadway at the given time only when at least one of the one or more additional criteria is satisfied. The one or more additional criteria include a first criterion that is satisfied only when the agent has a consistent heading that is away from the roadway for a second threshold amount of time after the given time. The additional criteria include a second criterion that is satisfied only when the agent has a distance from an edge of the roadway that is larger than a threshold distance. The additional criteria include a third criterion that is satisfied only when the future data indicates the agent remains sitting or bending over. The additional criteria include a fourth criterion that is satisfied only when the agent does not cross the roadway even though the future data indicates a window of opportunity to cross. The additional criteria include a fifth criterion that is satisfied only when the agent does not cross the roadway even though the future data indicates other agents are crossing the roadway.

Particular embodiments of the subject matter described in this specification can be implemented so as to realize one or more of the following advantages.

The system described in this specification can automatically generate a large amount of training data for training a machine learning model to generate roadway crossing intent predictions for agents in an environment. High quality intent labels can be automatically generated by combining future data characterizing the agent and the environment and what actually happened in the future time period. For example, when the agent did not cross the roadway in a future time period, the system does not automatically determine that the agent did not intend to cross the roadway. Instead, the system can generate more accurate labels by evaluating one or more additional criteria based on context information and determining that the agent did not intend to cross the roadway only when at least one or more additional criteria is satisfied. In some implementations, when the one or more additional criteria are not satisfied, the system can determine that the intent label is uncertain and can remove the training example from the training data. The system can flag the training example for manual review by a labeler, thus requiring the labeler to manually review only a small fraction of the total training examples.

The system can speed up the labeling process and can save the required computation time because the amount of context information used is adjustable and can be based on what happened in the future period of time and the length of the available future data characterizing the agent and the environment. For example, if the pedestrian executed the crossing action, the system does not need to analyze the context information because the execution of the crossing action is strong evidence that the pedestrian intended to cross the road. When the future data is available over a longer period of time, the system can use less additional criteria to determine the intent label. When future data is available over a shorter period of time, the system can use more additional criteria to determine the intent label.

Unlike the subjective labels generated by human labelers, the intent labels generated by the system are standardized and are more consistent because the system applies the same automatic labeling process and labeling logic to all the training examples. For example, if a pedestrian is standing near an intersection, rather than subjectively determining whether the pedestrian intended to cross the roadway based on various factors and generating inconsistent results by human labelers, the system applies the same automatic process and the same set of criteria to generate the intent labels. Therefore, the labeled training data can be used to effectively train and evaluate intent prediction machine learning models.

In some cases, instead of a binary label, e.g., cross or not-cross, the intent label can be a soft label, e.g., a value within a range of [0, 1], indicating a likelihood that the agent intended to cross the roadway at a given time. For instance, if the system is not able to determine whether the pedestrian intended to cross the roadway, the system can assign a label of 0.4 if the system determines that there is a 40% chance that the agent intended to cross the roadway. The system can generate more training data with soft labels because the system can keep the training examples even when the system cannot assign definitive positive or negative labels to the training examples. The system can train the machine learning models on such soft labels, e.g., by using a cross entropy loss function, and, as a result, can produce better predictions at inference time after the training is completed. By training with soft labels, the trained model can be more robust to label noise, such as inaccuracy or inconsistency within the labels of the training data.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example system.

FIG. 2 is a flowchart of an example process for generating a roadway crossing intent label.

FIG. 3 is a flowchart of an example process for generating a roadway crossing intent label based on context information.

Like reference numbers and designations in the various drawings indicate like elements.

### DETAILED DESCRIPTION

This specification describes how a training system can generate training data for training a machine learning model to perform roadway crossing intent prediction. Once the model has been trained, a vehicle, e.g., an autonomous or semi-autonomous vehicle, can use the machine learning model to generate roadway crossing intent predictions for one or more agents in the environment.

As used in this description, a “fully-learned” machine learning model is a model that is trained to compute a desired prediction. In other words, a fully-learned model generates an output based solely on training data rather than on human-programmed decision logic.

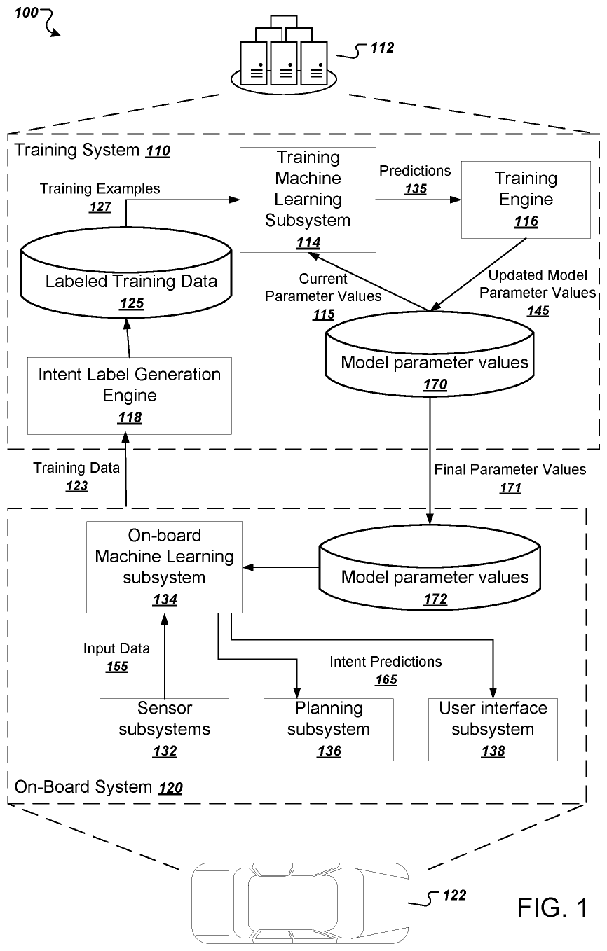

FIG. 1 is a diagram of an example system 100. The system 100 includes a training system 110 and an on-board system 120.

The on-board system 120 is physically located on-board a vehicle 122. Being on-board the vehicle 122 means that the on-board system 120 includes components that travel along with the vehicle 122, e.g., power supplies, computing hardware, and sensors. The vehicle 122 in FIG. 1 is illustrated as an automobile, but the on-board system 120 can be located on-board any appropriate vehicle type. The vehicle 122 can be a fully autonomous vehicle that uses intent predictions to inform fully-autonomous driving decisions. The vehicle 122 can also be a semi-autonomous vehicle that uses intent predictions to aid a human driver. For example, the vehicle 122 can autonomously apply the brakes if an intent prediction indicates that a pedestrian intends to cross a roadway. As another example, the vehicle 122 can send a notification signal to a human driver if an intent prediction indicates that a cyclist intends to cross the roadway.

The on-board system 120 includes one or more sensor subsystems 132. The sensor subsystems include a combination of components that receive reflections of electromagnetic radiation, e.g., laser systems that detect reflections of laser light, radar systems that detect reflections of radio waves, and camera systems that detect reflections of visible light.

The sensor subsystems 132 provide input data 155 to an on-board machine learning subsystem 134. The input data 155 characterizes a scene in the vicinity of the autonomous vehicle as of a given time, including an agent in an environment. The agent can be a dynamic object in the environment, e.g., a cyclist, or a pedestrian, and so on. For example, the input data 155 can include an image of a scene that includes a cyclist or a pedestrian captured by the camera systems or a point cloud representing a laser sensor measurement of the scene that includes the cyclist or pedestrian. The input data 155 can characterize the scene over a recent time period ending at the given time. For example, the input data can be a sequence of images or point clouds.

The on-board machine learning subsystem 134 implements the operations of a machine learning model, e.g., operations of each layer of a neural network, trained to predict the roadway crossing intent of the agent in the environment at the given time characterized in the input data 155. The on-board machine learning subsystem 134 includes one or more computing devices having software or hardware modules that implement the respective operations of a machine learning model, e.g., operations of a neural network according to an architecture of the neural network.

The on-board machine learning subsystem 134 can implement the operations of a machine learning model by loading a collection of model parameter values 172 that are received from the training system 110. Although illustrated as being logically separated, the model parameter values 172 and the software or hardware modules performing the operations may actually be located on the same computing device or, in the case of an executing software module, stored within the same memory device.

The on-board machine learning subsystem 134 can use hardware acceleration or other special-purpose computing devices to implement the operations of a machine learning model. For example, some operations of some layers of a neural network model may be performed by highly parallelized hardware, e.g., by a graphics processing unit or another kind of specialized computing device. In other words, not all operations of each layer need to be performed by central processing units (CPUs) of the on-board machine learning subsystem 134.

The on-board machine learning subsystem 134 generates roadway crossing intent predictions 165 for one or more agents in the environment based on input data 155 that characterizes the one or more agents in the environment at the given time. Each intent prediction 165 can include a likelihood that an agent intended to cross the roadway at the given time.

The agent's intent to cross the roadway can be lawful or unlawful. For example, the intent prediction 165 can include a likelihood of an intent to cross the roadway when the traffic rules indicate that crossing is permitted. As another example, the intent prediction 165 can include a likelihood of an intent of jaywalk. Jaywalking occurs when a pedestrian or a cyclist crosses a roadway when the traffic rules indicate that crossing is not permitted, for example, at a point in the roadway that is not identified as a crossing point or when a crossing light indicates that crossing is not allowed. For example, the intent prediction can include a likelihood that a cyclist intended to cross the roadway unlawfully.

The agent's intent to cross the roadway can include an intent to cross the roadway from a location that is off the road to a location on the road, or from a location that is on the road to a location that is off the road. For example, the system can determine whether a pedestrian standing at a bus station intends to cross the road from the sidewalk to the middle of the road. As another example, the system can determine whether a police officer standing in the middle of the road intends to stay on the road, or intends to move off the road.

In some implementations, the intent prediction 165 can include a roadway crossing direction, a roadway crossing speed, or a predicted trajectory for the predicted roadway crossing intent. For example, a roadway crossing direction can include a vector indicating the direction that the agent is likely to cross the roadway. The predicted trajectory can include a sequence of predicted locations of the agent at a sequence of time points in a future period of time.

The on-board machine learning subsystem 134 can provide the intent predictions 165 to a planning subsystem 136, a user interface subsystem 138, or both.

When a planning subsystem 136 receives the intent predictions 165, the planning subsystem 136 can use the intent predictions 165 to make fully-autonomous or semi-autonomous driving decisions. For example, the planning subsystem 136 can generate a fully-autonomous plan to slow down if an intent prediction of a nearby pedestrian indicates that the pedestrian intends to cross the roadway in front of the autonomous vehicle. As another example, the planning subsystem 136 can generate a semi-autonomous recommendation for a human driver to apply the brakes if an intent prediction indicates that a nearby cyclist is about to cross the roadway.

A user interface subsystem 138 can receive the intent predictions 165 and can generate a user interface presentation that indicates intent predictions of nearby agents. For example, the user interface subsystem 138 can generate a user interface presentation having image or video data containing a representation of a roadway crossing intent prediction of a nearby agent. An on-board display device can then display the user interface presentation for passengers of the vehicle 122.

The on-board machine learning subsystem 134 can also use the input data 155 to generate training data 123. The on-board system 120 can provide the training data 123 to the training system 110 in offline batches or in an online fashion, e.g., continually whenever it is generated.

The training system 110 is typically hosted within a data center 112, which can be a distributed computing system having hundreds or thousands of computers in one or more locations.

The training system 110 includes a training machine learning subsystem 114 that can implement the operations of a machine learning model that is designed to perform roadway crossing intent predictions from input data. The training machine learning subsystem 114 includes a plurality of computing devices having software or hardware modules that implement the respective operations of a machine learning model.

The training machine learning model generally has the same model architecture as the on-board machine learning model. However, the training system 110 need not use the same hardware to compute the operations of each layer. In other words, the training system 110 can use CPUs only, highly parallelized hardware, or some combination of these.

The training machine learning subsystem 114 can compute the operations of the machine learning model using current parameter values 115 stored in a collection of model parameter values 170. Although illustrated as being logically separated, the model parameter values 170 and the software or hardware modules performing the operations may actually be located on the same computing device or on the same memory device.

The training system 110 or the on-board system 120 can generate labeled training data 125 from the training data 123. The labeled training data 125 includes training examples 127, and each training example includes a training input and an intent label. Each training input includes data characterizing an agent in an environment as of the given time, and the agent is located in the vicinity of a roadway in the environment at the given time. For example, the training input can include a camera image of the scene and a top-down road graph rendering the surroundings of a pedestrian standing by the curb of the roadway.

An intent label for a training input can include a likelihood that the agent intended to cross the roadway at the given time. In some implementations, the intent label can be a binary label, e.g., “1” for intending to cross the roadway and “0” for not intending to cross the roadway. In some implementations, the intent label can be a soft label that includes a likelihood that the agent intended to cross the roadway at the given time that can take a value between zero and one, e.g., a probability of 0.8.

The training system 110 includes an intent label generation engine 118. The intent label generation engine 118 can generate labeled training data 125 by determining an intent label for the agent from future data.

The future data characterizes (i) the agent, (ii) the environment, or (iii) both the agent and the environment over a future time period that is after the given time.

For example, the training system 110 can obtain future data that indicates whether the agent crossed the roadway within a threshold amount of time after the given time. The future data can indicate behavior of the pedestrian over a future time period, such as the heading direction of the pedestrian at multiple time points in the future time period, the pedestrian's distance from the edge of the roadway at multiple time points in the future time period, or whether the pedestrian is sitting during the future time period, and so on.

The future data can include information about the environment over the future time period, such as whether other agents were crossing the roadway, traffic light information, whether other vehicles yielded to the pedestrian, and so on.

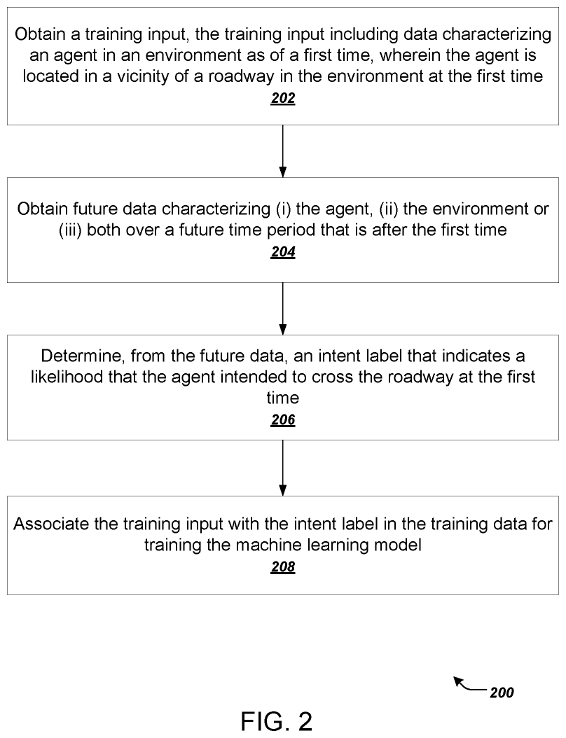

More details regarding generating a roadway crossing intent label from future data will be described in connection with FIG. 2.

After generating the intent label for a training input, the system can associate the intent label with the training input, resulting in labeled training data 125.

The training machine learning subsystem 114 trains a machine learning model on the labeled training data 125. The training machine learning subsystem 114 can select a set of training examples 127 from the labeled training data 125. The training machine learning subsystem 114 can generate, for each training example 123, a roadway crossing intent prediction 135. The intent prediction 135 can include a score that represents a likelihood that an agent in the training input intended to cross the roadway at the given time. In some implementations, the intent prediction 135 can include a property of the predicted intent, e.g., a roadway crossing direction, or a predicted trajectory for the predicted roadway crossing intent. A training engine 116 analyzes the intent predictions 135 and compares the intent predictions to the labels in the training examples 127. The training engine 116 then generates updated model parameter values 145 by using an appropriate updating technique based on differences between the intent predictions 135 and the intent labels. For example, when training a neural network model, the training engine 116 can generate updated model parameter values by stochastic gradient descent with backpropagation. The training engine 116 can then update the collection of model parameter values 170 using the updated model parameter values 145.

After training is complete, the training system 110 can provide a final set of model parameter values 171 to the on-board system 120 for use in making fully autonomous or semi-autonomous driving decisions. The training system 110 can provide the final set of model parameter values 171 by a wired or wireless connection to the on-board system 120.

FIG. 2 is a flowchart of an example process 200 for generating a roadway crossing intent label. The process will be described as being performed by a system of one or more computers in one or more locations, appropriately programmed in accordance with this specification. For example, the system can be a training system, e.g., the training system 110 of FIG. 1. As another example, the system can be an on-board system located on-board a vehicle, e.g., the on-board system 120 of FIG. 1. In this example, the on-board system can provide the roadway crossing intent label, once generated, to the training system for use in training a machine learning model.

The system obtains data identifying a training input for training a machine learning model to generate a roadway crossing intent prediction for an agent in an environment (202). The agent is located in the vicinity of a roadway in the environment at the given time. The agent can be stationary or moving at the given time. For example, the agent can be a pedestrian standing near an intersection, a cyclist travelling on the side road, or a construction worker working in a construction zone of the road, and so on.

The training input includes data characterizing the agent as of the given time or over a recent time period ending at the given time, e.g., one or more camera images captured by the camera sensors of the autonomous vehicle 122, or a point cloud representing a laser sensor measurement of the scene that includes the agent, or a combination of multiple kinds of sensor data. The data identifying the training input can include a timestamp of the given time.

The system obtains future data characterizing (i) the agent, (ii) the environment, or (iii) both the agent and the environment over a future time period that is after the given time (204). The future data can include context information of the environment that indicates whether the agent intended to cross the roadway and whether the agent executed the crossing action within a further time period.

In some implementations, the future data can indicate whether the agent crossed or entered the roadway within a first threshold amount of time after the given time. For example, the future data can include a video depicting that the pedestrian crossed the road within 10 seconds after the given time. As another example, the future data can include an image captured after the given time that indicates the cyclist did not cross the roadway within 20 seconds after the given time.

In some implementations, the future data can include context information characterizing the agent and/or the environment over a future time period that is after the given time. The system can obtain the context information from raw sensor data, the outputs of the perception system, or both. The perception system can detect an agent in the environment, the state of the traffic light, the pose and heading direction of the agent. The perception system can perform tracking of the agent and can perform semantic understanding, scene understanding of the environment, and so on in order to extract the context information.

The context information characterizing the agent can include the agent's pose, location, heading direction, and so on, over a future time period that is after the given time. For example, the future data can include the pedestrian's pose that lasted 10 seconds after the given time T0, such as standing, bending over, or sitting down. The future data can include the pedestrian's location, such as the distance from the pedestrian's location to the road edge. The future data can include the pedestrian's heading direction, i.e., the direction in which the pedestrian is facing or travelling. From the pedestrian's heading direction, the system can determine characteristics of the pedestrian, such as looking into the road, looking away from the road, talking to a friend, reading the bus schedule at a bus stop, and so on.

In some implementations, the future data can include information of other agents near the agent of interest. The other agents near the agent of interest can include a nearby pedestrian, car, cyclist and so on. The information of the other agents can include a pose, a location, a heading direction, and so on, of a nearby agent. For example, if other pedestrians in the vicinity of the agent crossed the roadway within a period of time (e.g., 10 seconds) after the given time T0, it indicates the agent had an opportunity to cross the roadway. As another example, if there were no other vehicles on the roadway approaching the pedestrian agent, it indicates that the agent had an opportunity to cross the roadway. As another example, the future data can include information about whether a vehicle is loading or unloading people or cargo, or when the agent is at a bus stop, whether other agents who are waiting at the bus stop are correlated with the agent of interest, and so on.

In some implementations, the future data can include context information of the environment in the vicinity of the agent over a future time period that is after the given time. For example, the future data can include data indicating whether the agent had an opportunity to cross the roadway over a future time period. If the crossing light or other signal that indicates to agents whether it is permitted to cross the roadway indicated that it was permitted to cross the roadway within a period of time (e.g., 15 seconds) after the given time T0, it indicates the agent had an opportunity to cross the roadway. Other context information of the environment can include whether construction is going on in the vicinity of the agent, whether the pedestrian wears a specific uniform, e.g., a uniform of a road worker, and so on.

The system determines, from the future data, an intent label that indicates a likelihood that the agent intended to cross the roadway at the given time (206). In some implementations, the intent label can be a binary label. For example, the system can assign a label of 0 if the system determines the agent did not intend to cross the roadway at the given time, and the system can assign a label of 1 if the system determines the agent intended to cross the roadway at the given time.

In some implementations, the system can determine that the agent intended to cross the roadway at the given time when the future data indicates that the agent crossed or entered the roadway within the first threshold amount of time. The system does not need to analyze additional context information in the future data because the execution of the crossing action is strong evidence that the agent intended to cross the road. For example, when the future data indicates a cyclist crossed the roadway 10 seconds after the given time T0, it is a strong indication that the cyclist intended to cross the roadway. The system can determine that the cyclist intended to cross the roadway at the given time T0.

In some implementations, the system can determine that the future data indicates that the agent executed some action within the first threshold amount of time, and the system can determine a roadway crossing intent label based on the execution of the action. First, the system can generate an action label based on evaluating the future data of the agent and the environment. For example, the system can generate action labels such as crossing, jaywalking, yielding, entering a vehicle, walking along the road, standing, and so on. Next, the system can generate a positive roadway crossing intent label for some action labels that indicate the agent intended to cross the roadway, e.g., crossing, jaywalking, yielding, and so on. The system can generate a negative roadway crossing intent label for some action labels that indicate the agent did not intend to cross the roadway, e.g., entering a vehicle, walking along the road, standing, and so on.

For example, the system can generate a “crossing” action label based on determining whether the agent crossed the road inside a crosswalk region. The system can generate a “jaywalking” action label based on determining whether the agent crossed the road outside a crosswalk section. The system can generate a “yielding” action label based on determining whether the agent crossed the road after yielding to another agent. The system can generate an “entering an vehicle” action label based on determining whether the agent moved toward a parked vehicle to enter the vehicle, or based on determining whether other agents are loading or unloading the vehicle, or based on determining whether the agent is talking with someone inside the vehicle, and in these situations the agent did not intend to cross the road. The system can generate a “walking along the road” label based on determining whether the pedestrian entered the road but did not cross the road, and based on determining whether the pedestrian walked along the sidewalk of the road. The system can generate a “standing” label based on determining whether the pedestrian is standing either on or off the road and did not execute a roadway crossing action. Based on the action label, the system can generate a roadway crossing intent label.

In some implementations, when the future data indicates that the agent did not cross or enter the roadway within the first threshold amount of time, the system does not automatically determine that the agent did not intend to cross the roadway. Instead, the system evaluates one or more additional criteria to determine the intent label.

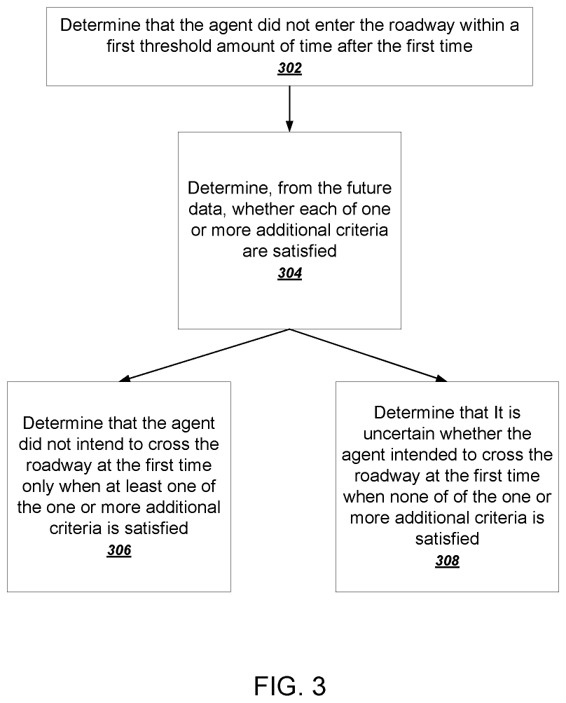

FIG. 3 is a flowchart of an example process for generating a roadway crossing intent label based on context information, such as one or more additional criteria. The process will be described as being performed by a system of one or more computers in one or more locations, appropriately programmed in accordance with this specification. For example, the system can be a training system, e.g., the training system 110 of FIG. 1. As another example, the system can be an on-board system located on-board a vehicle, e.g., the on-board system 120 of FIG. 1. In this example, the on-board system can provide the roadway crossing intent label, once generated, to the training system for use in training a machine learning model.

The system determines that the agent did not cross or enter the roadway within the first threshold amount of time after the given time (302). For example, the system determines, from the future data, that a pedestrian is stationary for a period of time, e.g., more than 20 seconds. As another example, the system determines, from the future data, that the pedestrian is not stationary but is moving away from the roadway for a period of time, or is moving in a direction that is in parallel to the roadway for a period of time. In this situation, the system does not commit to generate an intent label that indicates the pedestrian did not intend to cross the roadway. Instead, the system can check for more context information.

The system determines, from the future data, whether each of one or more additional criteria are satisfied (304). The one or more additional criteria can be based on the future data characterizing (i) the agent, (ii) the environment, or (iii) both the agent and the environment over a future time period that is after the given time.

The one or more additional criteria can include any of a variety of criteria that evaluate the future behavior of the agent during the future time period, the future state of the environment during the future time period, or both.

As one example, the criteria can include a criterion that is satisfied only when the agent has a consistent heading that is away from the roadway for a threshold amount of time after the given time. For example, the system can determine whether the heading angle of the agent is within a predetermined range, e.g., 120 degree range, of the direction that is away from the road for the threshold amount of time, e.g., 10 seconds, after the given time, and if yes, the criterion is satisfied.

As another example, the criteria can include a criterion that is satisfied only when the agent has a distance from an edge of the roadway that is larger than a threshold distance. For example, the system can determine whether the agent has a distance from the edge of the roadway that is larger than 5 meters, and if yes, the criterion is satisfied.

As another example, the criteria can include a criterion that is satisfied only when the future data indicates the agent remains sitting or bending over for a threshold amount of time after the given time. For example, the system can determine the posture of the agent based on the height and the width of the agent. If the ratio of the height and the width of the agent is less than a threshold value, the system can determine that the agent is sitting or bending over. If the height of the agent stays within a predetermined range, e.g., [0.3, 1.1] meters, and the keypoints of the agent indicate a sitting or bending over position and the agent is not a child, the system can determine that the agent is sitting or bending over. And if the system determines that the agent remains sitting or bending over for a threshold amount of time after the given time, the criterion is satisfied.

As another example, the criteria can include a criterion that is satisfied only when the agent does not cross the roadway even though the future data indicates a window of opportunity to cross. For example, the system can determine that the future data indicates a window of opportunity to cross when a crossing light or other signal indicated that the agent was permitted to cross the roadway, or when the roadway is empty, or when other vehicles yield to the agent and give the agent a chance to cross the roadway. The system can determine that the pedestrian does not cross the roadway even though the future data indicates the pedestrian has an opportunity to cross, and then the system can determine that the criterion is satisfied.

As another example, the criteria can include a criterion that is satisfied when the agent does not cross the roadway even though the future data indicates other agents are crossing the roadway. For example, the system can determine that the number of nearby agents crossing the roadway is larger than a threshold number, e.g., at least two of initially nearby agents are crossing the roadway. The system can determine the criterion is satisfied if the agent does not cross the roadway even though other agents are crossing the roadway.

As another example, the criteria can include a criterion that is satisfied when the agent is close to a vehicle that is loading or unloading passengers or cargo. The system can determine that the agent is correlated to the vehicle that is loading or unloading the passengers or cargo, e.g., the agent is waiting for another passenger getting off the vehicle, or the agent is helping with the loading of the cargo, and so on. Therefore, the system can determine that the criterion is satisfied.

As another example, the criteria can include a criterion that is satisfied when the agent is working on the roadway. For example, the system can determine whether the agent is a construction worker working on the roadway based on whether the agent is in a construction zone, or whether the agent is wearing a construction worker uniform. The system can determine whether the agent is a police officer working on the roadway based on whether the agent is wearing a police uniform, or whether the agent is near a police car. The system can determine that the criterion is satisfied when the system determines the agent is working on the roadway.

As one example, the criteria can include a criterion that is satisfied only when the agent's behavior indicates that the agent is not likely interested in crossing or entering the roadway for a threshold amount of time after the given time. The system can obtain the agent's behavior using one or more machine learning models that detects the agent's behavior from input data. For example, the system can determine whether the agent is looking at his or her phone for the threshold amount of time, e.g., 10 seconds, after the given time, and if yes, the criterion is satisfied. As another example, the system can determine whether the agent is standing or sitting near a bus station for the threshold amount of time, e.g., 10 seconds, after the given time, and if yes, the criterion is satisfied. As another example, the system can determine whether the agent is talking to another agent for the threshold amount of time, e.g., 10 seconds, after the given time, and if yes, the criterion is satisfied. As another example, the system can determine whether the agent is loading a truck for the threshold amount of time, e.g., 10 seconds, after the given time, and if yes, the criterion is satisfied.

The system determines that the agent did not intend to cross the roadway at the given time only when at least one of the one or more additional criteria is satisfied (306). In some implementations, the system can determine to use fewer or more additional criteria depending on the length of the future data that is available. When the future data depicts the agent and/or the environment for a long period of time after the given time, e.g., larger than 20 seconds after T0, the system can determine that the agent did not intend to cross the roadway at the given time when only one of the additional criteria is satisfied. When the future data depicts the agent and/or the environment for a short period of time after the given time, e.g., less than 20 seconds after T0, the system can determine that the agent did not intend to cross the roadway at the given time only when two or more additional criteria are satisfied.

For example, if the future data depicts the pedestrian and the environment for a long time after the given time, e.g., larger than 20 seconds after T0, and the pedestrian did not cross the roadway during the long period of time, the system can check for more context information that indicates the agent did not intend to cross. If the pedestrian is far from the road edge, the system can determine the pedestrian did not intend to cross the roadway at time T0. If the pedestrian is consistently not looking into the crossing direction, the system can determine the pedestrian did not intend to cross the roadway at T0. If the pedestrian is sitting down, the system can determine the pedestrian did not intend to cross the roadway at T0. If the pedestrian had the chance to cross the roadway, e.g., a crossing light indicated that the pedestrian was permitted to cross the roadway, but the pedestrian did not cross, the system can determine the pedestrian did not intend to cross the roadway at T0. If the pedestrian had the chance to cross because other pedestrians were crossing the roadway, but the pedestrian of interest did not cross the roadway, the system can determine the pedestrian did not intend to cross the roadway at T0. If the other pedestrians nearby are standing and are not crossing, the system can determine the pedestrian of interest is at a waiting area, e.g., a bus stop, and the pedestrian did not intend to cross the roadway.

As another example, if the future data depicts the pedestrian and the environment for a short time after the given time, e.g., shorter than 20 seconds after T0, and the pedestrian did not cross the roadway during the short period of time after the given time, the system can check for stronger context information that indicates the agent did not intend to cross. If the pedestrian had the chance to cross, e.g., a crossing light indicated that the pedestrian was permitted to cross the roadway, but the pedestrian did not cross the roadway, the system can determine the pedestrian did not intend to cross the roadway at T0 only if one or more other criteria are satisfied, e.g., the pedestrian being far from the road edge or heading away from the roadway. If the pedestrian had the chance to cross the roadway because other pedestrians were crossing the roadway, but the pedestrian of interest did not cross, the system can determine the pedestrian did not intend to cross the roadway at T0 only if one or more other criteria are satisfied, e.g., the pedestrian being far from the road edge or heading away from the roadway.

In some implementations, if the future data is available for a sufficiently long period of time, e.g., 2 or 3 minutes, the system can use what happened to the agent as evidence of the intent of the agent. For example, if a pedestrian did not cross the roadway after 5 minutes, the system can determine that the pedestrian did not intend to cross the roadway.

In some implementations, when the system determines that an agent is in the middle of the road at the given time, rather than automatically determining an intent to cross the roadway, the system can determine that the agent did not intend to cross the roadway at the given time when one or more additional criteria is satisfied. For example, the system can determine that the agent did not intend to cross the roadway because the agent is in a construction zone and is a construction worker wearing a construction worker uniform. As another example, although a policeman or a policewoman is in the middle of the road, the system can determine that the policeman or policewoman did not intend to cross the roadway because he or she is in a police uniform and is holding a stop sign to guide traffic when the traffic light is not functioning.

In some implementations, the system can use the similar technique to generate an intent label for an agent that is moving in the vicinity of the roadway. For example, the system can determine that a pedestrian walking on a sidewalk did not cross or enter the roadway within 20 seconds after the given time T0, and the system can determine that the pedestrian did not intend to cross the roadway at T0 when the pedestrian was continuously heading away from the road over the 20 seconds. In some implementations, the system can use additional context information of the moving agent to determine the intent label, e.g., the speed of the agent over a period of time. For example, if the cyclist travels at a constant speed along the edge of the road and is heading away from the road, the system can determine that the cyclist did not intend to cross the roadway.

In some implementations, the system can determine that it is uncertain whether the agent intended to cross the roadway at the given time when none of the one or more additional criteria is satisfied (308). The system can discard the training input, or label the training input as uncertain, and the system can determine to not use the training input to train the machine learning model. In some implementations, when the system determines that it is uncertain whether the agent intended to cross the roadway at the given time, the system can send the training input to a human labeler, and the human labeler can provide an intent label for the training input based on the human labeler's observation. Therefore, instead of asking the human labeler to review all the training examples, the system can require the human labeler to manually review only a small fraction of the total training examples.

In some implementations, the intent label can be a soft label that includes a likelihood that the agent intended to cross the roadway at the given time. For example, the system can assign a label with a value of 0.4 if the system determines that there is a 40% chance that the agent intended to cross the roadway. The system can determine the probability that the agent intended to cross the roadway at the given time based on the length of the available future data and the number of additional criteria that are satisfied. For example, if the system can obtain future data that depicts the pedestrian for a longer period of time, and the system determines that two or more criteria that indicates the pedestrian did not intend to cross are satisfied, the system can determine that the probability that the pedestrian intended to cross the roadway at the given time is very low, e.g., 0.1. As another example, if the system can obtain future data that depicts the pedestrian for a shorter period of time, or the system determines that only one criterion is satisfied, the system can determine that the probability that the pedestrian intended to cross the roadway is uncertain, e.g., 0.4.

Returning back to FIG. 2, after the system determines the intent label, the system associates the training input with the intent label in the training data for training the machine learning model (208). The training data can include a plurality of training examples 127, and each training example 127 can include the training input and its corresponding intent label.

In some implementations, the system can train the machine learning model on the training data. The system can generate, for each training input in the training examples, an intent prediction. The intent prediction represents a predicted likelihood that the agent intended to cross the roadway. The system can compare the intent predictions to the intent labels in the training examples. The system can calculate a loss which can measure the difference between the intent predictions and the labels in the training examples. The loss can include a classification loss that can measure the differences between intent probabilities for each class, e.g., cross or not-cross, and the intent labels in the training examples.

In some implementations, the intent label can be a soft label, and the system can train the machine learning model on the soft labels using a cross-entropy loss. The cross-entropy loss can measure the similarity between two probability distributions, e.g., the predicted road crossing intent probability distribution and the intent distribution of the intent label. For example, the machine learning model can predict that there is a 70% chance that the agent intended to cross the roadway at the given time, and a 30% chance that the agent did not intend to cross the roadway at the given time. The intent label can be 80% cross and 20% not-cross. The system can use the cross-entropy loss to measure the similarity between the two probability distributions. If the training of the machine learning model is configured to minimize the value of the loss function, the system can generate a smaller loss value if the two distributions are closer to each other, and the system can generate a larger loss value if the two distributions are farther away from each other.

The system can then generate updated model parameter values based on the loss by using an appropriate updating technique, e.g., stochastic gradient descent with backpropagation. The system can then update the collection of model parameter values using the updated model parameter values.

In some implementations, the training data can include both an intent label and a behavior label for a training input. For example, the intent label indicates whether the agent intended to cross the roadway at the given time, and the behavior label indicates whether the agent actually crossed the roadway. The system can train the machine learning model to generate both the intent prediction and the behavior prediction on the training data. In some implementations, the behavior label is a subset of the intent label and the behavior label is only available when the future data captures the execution of the roadway crossing. In this case, the behavior prediction becomes a subset of the intent prediction.

In some implementations, the system can update the process 200 of generating a roadway crossing intent label by comparing the automatically generated intent labels with the human labels. The system can obtain a small set of training examples and can obtain human labels for the training inputs in the small set of training examples. The system can compare the human labels with the automatically generated intent labels. Based on the comparison result, the system can refine the process 200, e.g., using the context information in the future data in a different way, adding new context information, and so on. For example, the system can add one or more new criteria identified by the human labelers that can help the system more accurately determine the intent label.

In some implementations, the system can generate a label for other types of intent of an agent on the road based on future data characterizing the agent and the environment over a future time period. For example, based on future data characterizing the agent and the environment over a future time period, the system can generate a label for whether the agent intends to remain in the same location, intends to enter a vehicle, intends to keep the agent's current motion, e.g., keep walking along the road edge, and so on.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, off-the-shelf or custom-made parallel processing subsystems, e.g., a GPU or another kind of special-purpose processing subsystem. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g., a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain cases, multitasking and parallel processing may be advantageous.

What is claimed is:

1. A method of generating training data for training a machine learning model to generate roadway crossing intent predictions for agents in an environment, comprising:
obtaining data identifying a training input, the training input comprising data characterizing an agent in an environment as of a given time, wherein the agent is located in a vicinity of a roadway in the environment at the given time;
obtaining future data characterizing (i) the agent, (ii) the environment or (iii) both over a future time period that is after the given time;
determining, from the future data, an intent label that indicates a likelihood that the agent intended to cross the roadway at the given time; and
associating the training input with the intent label in the training data for training the machine learning model.

2. The method of claim 1, further comprising:
training the machine learning model on the training data.

3. The method of claim 1, wherein the intent label comprises a probability that the agent intended to cross the roadway at the given time.

4. The method of claim 1, wherein the intent label is a binary label.

5. The method of claim 1, wherein the future data indicates whether the agent crossed or entered the roadway within a first threshold amount of time after the given time, and wherein determining the intent label comprises:
determining that the agent intended to cross the roadway at the given time when the future data indicates that the agent crossed or entered the roadway within the first threshold amount of time.

6. The method of claim 1, wherein the future data indicates whether the agent crossed or entered the roadway within a first threshold amount of time after the given time, and wherein determining the intent label comprises:
when the future data indicates that the agent did not cross or enter the roadway within the first threshold amount of time:
determining, from the future data, whether each of one or more additional criteria are satisfied; and
determining that the agent did not intend to cross the roadway at the given time only when at least one of the one or more additional criteria is satisfied.

7. The method of claim 6, wherein the one or more additional criteria comprise a first criterion that is satisfied only when the agent has a consistent heading that is away from the roadway for a second threshold amount of time after the given time.

8. The method of claim 6, wherein the additional criteria comprise a second criterion that is satisfied only when the agent has a distance from an edge of the roadway that is larger than a threshold distance.

9. The method of claim 6, wherein the additional criteria comprise a third criterion that is satisfied only when the future data indicates the agent remains sitting or bending over.

10. The method of claim 6, wherein the additional criteria comprise a fourth criterion that is satisfied only when the agent does not cross the roadway even though the future data indicates a window of opportunity to cross.

11. The method of claim 6, wherein the additional criteria comprise a fifth criterion that is satisfied only when the agent does not cross the roadway even though the future data indicates other agents are crossing the roadway.

12. A system comprising one or more computers and one or more storage devices storing instructions that when executed by the one or more computers cause the one or more computers to perform operations comprising:
obtaining data identifying a training input, the training input comprising data characterizing an agent in an environment as of a given time, wherein the agent is located in a vicinity of a roadway in the environment at the given time;
obtaining future data characterizing (i) the agent, (ii) the environment or (iii) both over a future time period that is after the given time;
determining, from the future data, an intent label that indicates a likelihood that the agent intended to cross the roadway at the given time; and
associating the training input with the intent label in training data for training a machine learning model.

13. The system of claim 12, the operations further comprise:
training the machine learning model on the training data.

14. The system of claim 12, wherein the intent label comprises a probability that the agent intended to cross the roadway at the given time.

15. The system of claim 12, wherein the intent label is a binary label.

16. The system of claim 12, wherein the future data indicates whether the agent crossed or entered the roadway within a first threshold amount of time after the given time, and wherein determining the intent label comprises:
determining that the agent intended to cross the roadway at the given time when the future data indicates that the agent crossed or entered the roadway within the first threshold amount of time.

17. The system of claim 12, wherein the future data indicates whether the agent crossed or entered the roadway within a first threshold amount of time after the given time, and wherein determining the intent label comprises:
when the future data indicates that the agent did not cross or enter the roadway within the first threshold amount of time:
determining, from the future data, whether each of one or more additional criteria are satisfied; and
determining that the agent did not intend to cross the roadway at the given time only when at least one of the one or more additional criteria is satisfied.

18. The system of claim 17, wherein the one or more additional criteria comprise a first criterion that is satisfied only when the agent has a consistent heading that is away from the roadway for a second threshold amount of time after the given time.

19. The system of claim 17, wherein the additional criteria comprise a second criterion that is satisfied only when the agent has a distance from an edge of the roadway that is larger than a threshold distance.

20. One or more non-transitory computer-readable storage media storing instructions that when executed by one or more computers cause the one or more computers to perform operations comprising:
obtaining data identifying a training input, the training input comprising data characterizing an agent in an environment as of a given time, wherein the agent is located in a vicinity of a roadway in the environment at the given time;
obtaining future data characterizing (i) the agent, (ii) the environment or (iii) both over a future time period that is after the given time;
determining, from the future data, an intent label that indicates a likelihood that the agent intended to cross the roadway at the given time; and
associating the training input with the intent label in training data for training a machine learning model.
